(19) United States
(12) Patent Application Publication
(10) Pub. No.: US 2026/0115080 A1
(43) Pub. Date: Apr. 30, 2026

(54) SPINAL TRACTION DEVICE AND METHOD

(71) Applicant: Travis D. McCoy, Slidell, LA (US)

(72) Inventor: Travis D. McCoy, Slidell, LA (US)

(21) Appl. No.: 18/925,417

(22) Filed: Oct. 24, 2024

(51) Int. Cl. A61H 1/02; A61H 1/00

(52) U.S. Cl. CPC A61H 1/0222; A61H 1/005; A61H 2201/164; A61H 2201/1664; A61H 2201/1673; A61H 2201/1678; A61H 2201/5058; A61H 2203/0462

(57) ABSTRACT

An orthopedic traction device for applying a pulling force to one or more joints of a person includes a vertical system that is configured to support respective portions of one or both legs of the person. The vertical system has a vertical axis and includes an inferior structure, a superior structure above the inferior structure, and an actuation system configured to adjust a distance d1 between the superior structure and the inferior structure, and a distance d2 between the inferior structure and a reference plane beneath the inferior structure through movement of one or both of the superior structure and the inferior structure along the vertical axis. The device can include a horizontal base that supports the person lying horizontally. Alternatively, the device includes only the vertical system and the vertical system includes an attachment mechanism that enables it to be attached to a horizontal support structure.

### TECHNICAL FIELD

The present disclosure relates generally to orthopedic therapy devices and method, and more particularly, to spinal traction devices and methods of applying a pulling force or traction force to a joint.

### BACKGROUND

Spinal traction is a form of decompression therapy that relieves pressure on the spine. Spinal traction stretches the spine to take pressure off compressed discs. This straightens the spine and improves the body's ability to heal itself.

Numerous health benefits are provided by spinal traction. These benefits include:
1) Spinal Decompression:

Mechanism: Spinal traction creates space between the vertebrae, reducing intradiscal pressure. This negative pressure can retract bulging or herniated discs, which alleviates pressure on spinal nerves. Scientific Benefit: Decreased disc pressure can lead to reduced pain and enhanced healing of disc injuries.
2) Pain Relief

Mechanism: By reducing pressure on nerves, joints, intervertebral disc, and muscles, spinal traction can significantly decrease pain, particularly in conditions like herniated discs, sciatica, and degenerative disc disease. Scientific Benefit: Clinical studies show significant reductions in pain levels in patients undergoing regular traction therapy.
3) Improved Spinal Alignment

Mechanism: Regular traction can help correct minor misalignments in the spine by stretching spinal structures and allowing the vertebrae to return to their correct positions. Scientific Benefit: Proper spinal alignment can reduce the risk of developing chronic conditions, improve posture, and enhance biomechanical efficiency.
4) Nerve Root Relief

Mechanism: Traction reduces the pressure on nerve roots by decompressing the spine and creating more space within the spinal canal along with the neural foramens that surround the nerve roots. Scientific Benefit: Relief of nerve root compression can reduce symptoms such as pain, numbness, tingling, and muscle weakness, particularly in conditions like sciatica.
5) Improved Flexibility

Mechanism: Traction stretches the spine and surrounding soft tissues, including muscles, ligaments, and tendons, leading to improved flexibility. Scientific Benefit: Increased flexibility reduces the risk of injuries, enhances movement patterns, and contributes to overall musculoskeletal health.
6) Muscle Relaxation

Mechanism: The gentle stretching action of spinal traction can help relax paraspinal muscles by reducing muscle spasms and decreasing muscle tension. Scientific Benefit: Muscle relaxation can alleviate pain, improve mobility, and reduce the likelihood of muscle imbalances or compensatory patterns.
7) Joint Health

Mechanism: Traction decreases pressure on spinal joints (facet joints), promoting better joint lubrication and potentially slowing the progression of degenerative joint conditions. Scientific Benefit: Improved joint health can lead to enhanced mobility, reduced stiffness, and lower risk of osteoarthritis progression.
8) Improved Blood Circulation

Mechanism: Traction enhances blood flow by reducing muscle tension and improving the circulation of blood and nutrients to the spine and surrounding tissues. Scientific Benefit: Increased blood circulation promotes tissue healing, reduces inflammation, and can contribute to overall spinal health.
9) Reduced Need for Surgery

Mechanism: By addressing the root causes of spinal issues non-invasively, spinal traction can serve as an effective conservative treatment, potentially delaying or avoiding the need for spinal surgery. Scientific Benefit: Several studies suggest that patients with certain conditions may experience enough improvement with traction to avoid surgical intervention.
10) Stress Relief

Mechanism: The process of traction, especially in inversion therapy, induces a relaxation response in the body, reducing overall stress levels. Scientific Benefit: Stress relief has widespread benefits, including reduced cortisol levels, improved mental health, and better overall well-being, which indirectly supports spinal health.

Spinal traction can be performed manually or mechanically. In manual spinal traction, a physical therapist uses their hands to put people in a state of traction. Then they use manual force on the joints and muscles to widen the spaces between vertebrae. In one form of mechanical spinal traction, a person lies on a table that has special tools to stretch the spine. A physical therapist attaches a series of ropes, slings, and pulleys to the patient to mechanically relieve pressure. In another form of mechanical spinal traction, a person is hung upside down using an inversion table and the weight of the person serves as the traction force.

There are, however, significant health risks associated with hanging upside down for more than a few minutes. These risks include:

Increased blood pressure to the head: Blood can pool in the skull, which can lead to pressure building up in the brain and eyes. This can cause blood vessel congestion, which may lead to strokes or bleeding.

Slowed heartbeat: The inverted body position can increase the heart's workload, which can eventually lead to heart failure.

Restricted breathing: Hanging upside down can make it harder for the respiratory muscles to work, especially for people with asthma, emphysema, bronchitis, or pneumothorax.

### SUMMARY

This disclosure relates to a traction device for applying a pulling force (also called a “traction force” herein) to one or more back joints of a person while the person is lying horizontal with their legs bent at the knee and elevated relative to the torso. The traction device includes a vertical system that is configured to support respective portions of one or both legs of the person. The vertical system has a vertical axis and includes an inferior structure, a superior structure above the inferior structure, and an actuation system. The actuation system is configured to adjust a distance d1 between the superior structure and the inferior structure, and a distance d2 between the inferior structure and a reference plane beneath the inferior structure through movement of one or both of the superior structure and the inferior structure along the vertical axis. In some configurations the traction device includes a horizontal base that serves as the reference plane and supports the person lying horizontally and the vertical system is at an end of the base. In other configurations the traction device includes only the vertical system and the vertical system includes an attachment mechanism that enables the system to be attached to a horizontal support structure, e.g., a bed or a physical therapy table, that serves as the reference plane.

The disclosure also related to a method of applying a pulling force to spine vertebra of a person. The method includes, while the person is lying with their torso and pelvic region substantially horizontal with one or more lower extremities, e.g., legs, above the torso, securing the one or more lower extremities between an inferior structure and a superior structure of a traction device; and elevating the inferior structure and the superior structure along a vertical axis to displace at least a portion of the pelvic region from its substantially horizonal position to thereby suspend the portion of the pelvic region in the air and apply a pulling force to the spine vertebra. In some methods, the inferior structure and the superior structure are moved along a path that intersects the vertical axis. The path can be one of an arcuate path or a linear path. In some methods, the inferior structure together with the superior structure are moved a short distance, e.g., in a range of 0.1 to 6 inches, in a first direction along the vertical axis followed by the short distance in a second direction along the vertical axis opposite the first direction.

It is understood that other aspects of apparatuses and methods will become readily apparent to those skilled in the art from the following detailed description, wherein various aspects of apparatuses and methods are shown and described by way of illustration. As will be realized, these aspects may be implemented in other and different forms and its several details are capable of modification in various other respects.

### BRIEF DESCRIPTION OF THE DRAWINGS

Various aspects of apparatuses and methods will now be presented in the detailed description by way of example, and not by way of limitation, with reference to the accompanying drawings, wherein:

FIG. 1A is an side view illustration of a traction device having a horizontal base and a vertical system.

FIG. 1B is a front view illustration of the traction device of FIG. 1A.

FIG. 1C is a top view illustration of the traction device of FIG. 1A.

FIG. 1D is a bottom view illustration of a portion of the traction device of FIG. 1A.

FIG. 2 is an illustration of the vertical system of the traction device of FIGS. 1A-1D.

FIGS. 3A-3C are illustrations of components of the vertical system at different side-to-side arcuate motion positions.

FIGS. 4A-4C are illustrations of components of the vertical system at different side-to-side linear motion positions.

FIG. 5 is a flowchart of a method of applying a pulling force to a vertebra using the traction device of FIGS. 1A-1D.

FIGS. 6A-6C are illustrations of the method of FIG. 5.

### DETAILED DESCRIPTION

The devices and methods disclosed herein provide traction forces that increase the space between adjacent vertebra in the spine to thereby relieve back pain. The traction forces also increase the space between vertebra and discs, the space within a disc itself, the epidural space, and the neural foramen space. The traction device and methods allow a user the ability and variability to apply 0-65% of their own body weight as the traction force to properly align their spine while keeping their head relatively level with or higher than their heart to reduce cardiac risks.

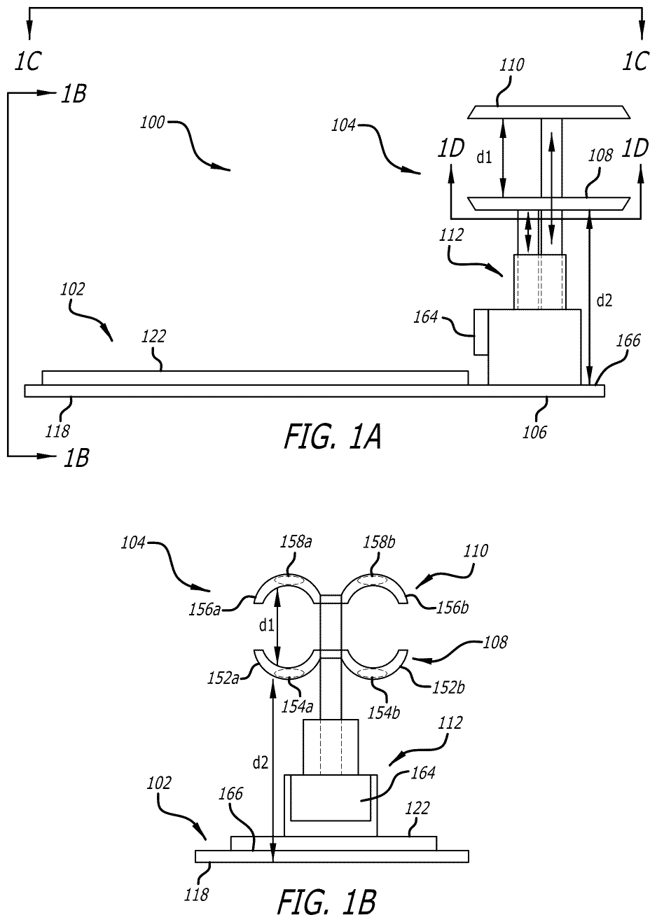

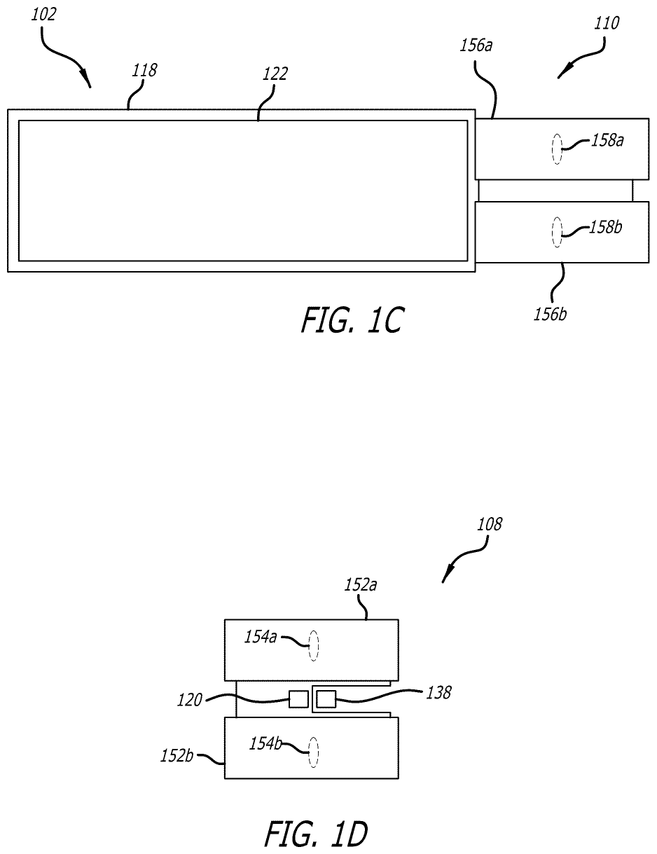

With reference to FIGS. 1A-1D, a traction device 100 for applying a pulling force to a joint of a person includes a horizontal base 102 and a vertical system 104 located at an end 106 of the horizontal base. The horizontal base 102 may extend a length from the vertical system 104 that is sufficient to support a person's upper body, e.g., the pelvic region to the head, in a horizontal orientation. The horizontal base 102 has a lower support 118 with a cushion 122 on top. In other embodiments, the horizontal base 102 may be of shorter length, with a square footprint and sufficiently sized and weighted to keep the traction device 100 from tipping over during use. In other embodiments, there is no horizontal base 102 and the traction device 100 comprises only the vertical system 104. In this embodiment, the vertical system 104 includes an attachment mechanism 164, e.g., a clamp, bracket, etc., that attaches the vertical system to a horizontal structure, e.g., a bed, table, etc., that supports the person's weight.

The vertical system 104 includes an inferior structure 108 and a superior structure 110 located above the inferior structure. The inferior structure 108 and the superior structure 110 are configured to support the lower extremities of a person, e.g., the portions of the legs below the knee, in a horizontal orientation and at an elevation above the person's upper body. As seen in FIG. 1B, the inferior structure 108 includes a pair of cushioned contour regions 152a, 152b with a large surface areas configured to support the calf side of the lower extremity. A large surface area in this context is a surface area that covers more than 25% of the posterior portion of the lower extremity which includes but is not limited to the fold of the knee down to the heel. This large surface area reduces the pounds per square inch of force on the patient's anatomy allowing for longer therapy session and more comfortable experience. In some embodiments, the inferior structure 108 comprises vibration mechanisms 154a, 154b that may be embedded in the cushioned contour regions 152a, 152b.

Likewise, the superior structure 110 includes a pair of cushioned contour regions 156a, 156b with a large surface areas configured to support the tibia side of the lower extremity. A large surface area in this context is a surface area that covers more than 25% of the anterior portion of the lower extremity which includes but is not limited to the anterior knee down to the foot. This large surface area reduces the pounds per square inch of force on the patient's anatomy allowing for longer therapy session and more comfortable experience. In some embodiments, the superior structure 110 comprises vibration mechanisms 158a, 158b that may be embedded in the cushioned contour regions 156a, 156b. The vibration mechanisms induce vibration of the lower extremity, which in turn distracts the central nervous system distraction to relax muscle and allow stretching. The large surface area of the inferior structure 108 spreads out the weight of the patient's lower extremities to improve patient comfort and reduce injury.

The vertical system 104 also includes an actuation system 112. The actuation system 112 is configured to adjust a distance d1 between the superior structure 110 and the inferior structure 108. The adjustment to distance d1 can be made by moving the superior structure 110 downward toward the inferior structure 108 without moving the inferior structure. The adjustment to distance d1 can be made by moving the inferior structure 108 upward toward the superior structure 110 without moving the superior structure. The adjustment to distance d1 can be made by moving both of the inferior structure 108 and the superior structure 110 toward each other.

The actuation system 112 is also configured to adjust a distance d2 between the inferior structure 108 and a horizontal plane 166. The adjustment to distance d2 is made by moving the inferior structure 108 and the superior structure 110 upward away from the horizontal plane 166. In some embodiments, movement of the inferior structure 108 and movement of the superior structure 110 is simultaneous. In other embodiments, movement of the inferior structure 108 and the superior structure 110 is alternating, wherein the superior structure 110 is moved upward away from the horizontal plane 166 without moving the inferior structure 108; and then the inferior structure 108 is moved upward away from the horizontal plane 166 without moving the superior structure 110.

In the embodiment shown in FIG. 1A, the horizontal plane 166 corresponds to a plane surface of the horizontal base 102. In embodiments without a horizontal base 102, the horizontal plane 166 may be in relation to the actuation system 112. For example, the horizontal plane 166 may be a plane surface at the lower end of the actuation system 112. Alternatively, the horizontal plane 166 may be a plane surface of a table or bed to which the traction device 100 is attached.

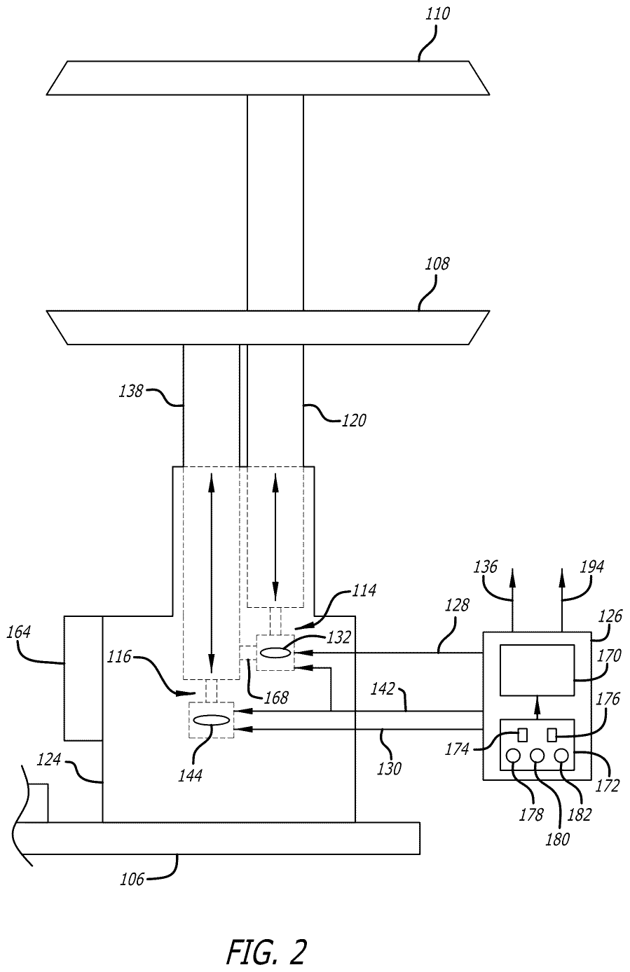

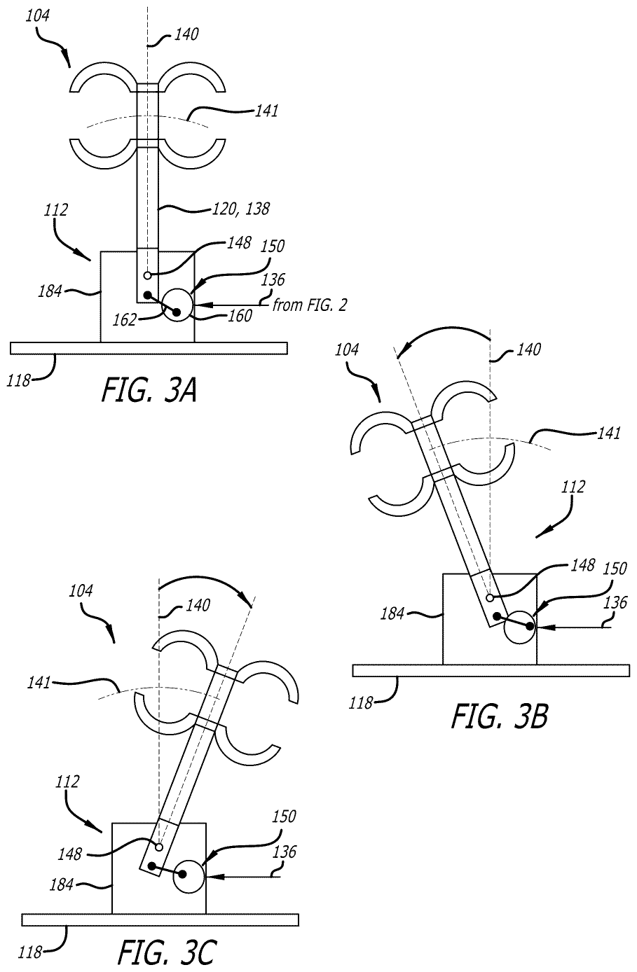

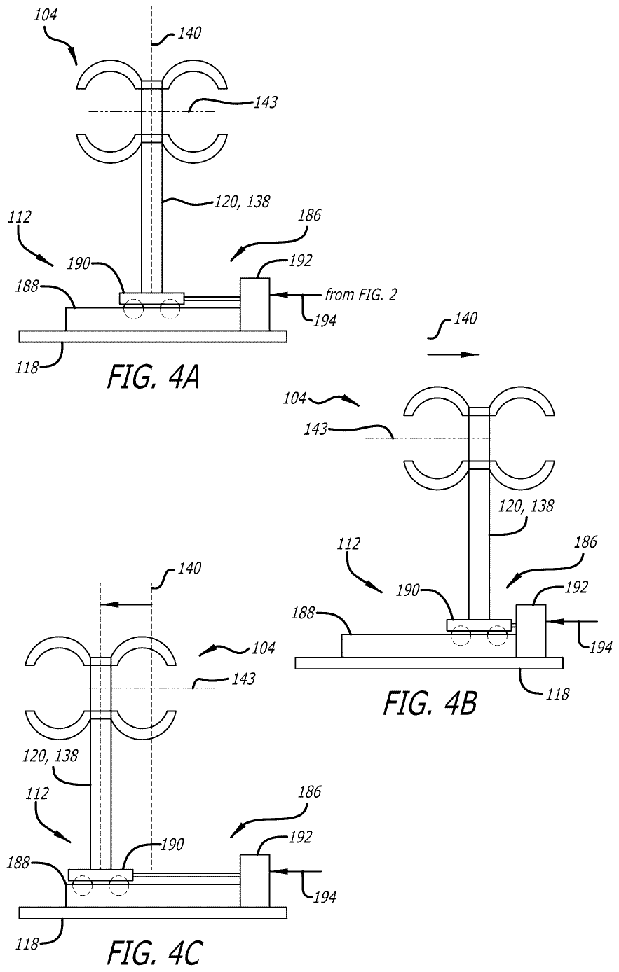

With reference to FIG. 2, the actuation system 112 includes a superior actuator 114 and an inferior actuator 116 within a housing 124. The actuation system 112 also includes a controller 126 that is configured to control operation of the superior actuator 114 and the inferior actuator 116. The controller 126 includes an actuation module 170 and a user interface module 172. The actuation module 170 is configured or programmed to control operations of the superior actuator 114 and the inferior actuator 116 based on a control signals received from the user interface module 172. The user interface module 172 is describe below as including mechanical buttons and dials that control the actuation module 170. It is understood that the functionality of such buttons and dials may be implemented using numerous other means including, for example, touch screen technology. For clarity of illustration, in FIG. 2 the controller 126 is shown entirely outside of the housing 124 of the actuation system 112. The actuation module 170, however, may be within the housing 124 while the user interface module 172 is exterior the housing 124.

The superior actuator 114 is coupled to a post 120 that is coupled to the superior structure 110. The superior actuator 114 is operable to move the post 120 up and down based on a control signal 128 from the controller 126. The superior actuator 114 may be a linear actuator that creates motion in a straight line. The superior actuator 114 may be a commercially available linear actuator, e.g., IP65 mini linear actuator by Progressive Automations, that may be modified to fit within the housing of the actuation system 112. The superior actuator 114 may be a mechanical or electro mechanical linear actuator, a hydraulic linear actuator, a pneumatic linear actuator, a piezoelectric actuators, a solenoid actuator, or functional equivalents thereof.

The controller 126 has a first control button 174, e.g., a first up/down toggle button. When toggled up and held in that position, the controller 126 outputs a control signal 128 that causes the superior actuator 114 to move the post 120 and the superior structure 110 upward. When the toggle button 174 is released, upward movement stops. Likewise, when toggled down and held in that position, the controller 126 outputs a control signal 128 that causes the superior actuator 114 to move the post 120 and the superior structure 110 downward. When the toggle button is released, downward movement stops.

With continued reference to FIG. 2, the inferior actuator 116 is coupled to a post 138 that is coupled to the inferior structure 108. The inferior actuator 116 is operable to move the post 138 up and down based on a control signal 130 from the controller 126. The inferior actuator 116 may be of similar structure as the superior actuator 114.

The controller 126 has a second control button 176, e.g., a second up/down toggle button. When toggled up and held in that position, the controller 126 outputs a control signal 130 that causes simultaneous operation of the inferior actuator 116 and the superior actuator 114, during which the inferior actuator 116 moves the post 138 and the inferior structure 108 upward while the superior actuator 114 moves the post 120 and the superior structure 110 upward. When the toggle button 176 is released, the upward movements stop. Likewise, when toggled down and held in that position, the controller 126 outputs a control signal 130 that causes simultaneous operation of the inferior actuator 116 and the superior actuator 114, during which the inferior actuator 116 moves the post 138 and the inferior structure 108 downward while the superior actuator 114 moves the post 120 and the superior structure 110 downward. When the toggle button 176 is released, the downward movements stop.

With reference to FIG. 2, in some embodiments the superior actuator 114 and the inferior actuator 116 are mechanically coupled relative to each other such that operation of the inferior actuator 116 moves the inferior structure 108 together with the superior structure 110. To this end, a mechanical coupling 168 attaches the superior actuator 114 to the post 138 that is moved by the inferior actuator 116.

In some embodiments, the superior actuator 114 includes a sensor 132 configured to output a measurement indicative of resistance against downward movement of the superior structure 110, which resistance corresponds to a measure of force against the lower extremity. In some embodiments, the controller 126 receives the measurement and may display a measure of force that can be used as a therapy guide. For example, a downward force by the superior structure 110 on the tibia can reduce unwanted force behind the knee at a 1:4 ratio, where every pound of force pushing down on the tibia will relax the tendons behind the knee by 4 pounds. This ratio will vary from person to person depending on height and body mass index (BMI).

In some embodiments, the superior actuator 114 is configured to override control signals from the controller 126 to stop downward movement of the superior structure 110 when the measurement exceeds a threshold. The threshold may be in the range of 5 to 100 lbs. of resistance against downward movement, or in the range of 5 to 100 lbs. of force against the lower extremity. In some embodiments the threshold is fixed. In some embodiments the threshold is variable and may be set by the controller 126 to a value that ensures patient comfort. The sensor 132 provides a safety feature against painful compression of the patient's lower extremity by the superior structure 110 as it moves down and into contact with the lower extremity.

In some embodiments, the inferior actuator 116 includes a sensor 144 configured to output a measurement indicative of resistance against upward movement of the inferior structure 108 together with the superior structure 110. The inferior actuator 116 is configured to override control signals from the controller 126 to stop upward movement of the inferior structure 108 together with the superior structure 110 when the measurement exceeds a threshold. The threshold may be in the range of 10 to 200 lbs. of resistance against upward movement. In some embodiments the threshold is fixed. In some embodiments the threshold is variable and may be set by the controller 126 to a value that ensures both patient safety and therapy intensity. The sensor 144 provides a safety feature against over traction of the patient's spine by the traction device as the inferior structure together with the superior structure moves up.

In some embodiments the actuation system 112 is configured to cause a brief vertical movement of the inferior structure 108 together with the superior structure 110. For example, the brief movement may include a first movement of a short distance, e.g., 0.1 to 6 inches, in a first direction, e.g., upward or downward, that is immediately followed by a second movement of the same short distance in a second direction opposite the first direction. In some embodiments the first and second movements are quick/sudden to provide a jolting movement. In this context a quick/sudden movement has a speed in the range of 0.1 to 6 inches per 0.5 second. In another example, the first and second movements are slow. In this context a slow movement has a speed in the range of 0.1 to 6 inches per 10 seconds. In yet another example, the first movement is an upward movement of a short distance that is either quick/sudden or slow and the second movement is a free-fall downward movement of the same distance as the upward movement.

In any case, the brief vertical movement feature is controlled based on a control signal 142 output by the controller 126 to each of the inferior actuator 116 and the superior actuator 114, or just the inferior actuator 116 in configurations where the superior actuator 114 and the inferior actuator 116 are mechanically coupled relative to each other such that operation of the inferior actuator 116 moves the inferior structure 108 together with the superior structure 110. In one configuration, the controller 126 includes a first rotatable dial 178 that turns the brief vertical movement feature on and off. When the vertical movement feature is on, further rotation of the first rotatable dial 178 sets the frequency of brief movements, e.g., number of complete movements per minute, where a complete movement includes a first movement and a second movement.

With reference to FIGS. 3A-3C, in some embodiments, the actuation system 112 is configured to cause the inferior structure 108 and the superior structure 110 to oscillate back and forth along an arcuate path 141. Note, in FIGS. 3A-3C some components of the actuation system 112 shown in FIG. 2 are not included for clarity of illustration. These components include the housing 124, the superior actuator 114, and the inferior actuator 116.

Continuing with FIGS. 3A-3C, the actuation system 112 include a support 184 that defines a pivot point 148. The inferior structure 108 and the superior structure 110 are mounted to the support 184 relative to the pivot point 148. For example, the lower end of one or more of the posts 120, 138 of the inferior structure 108 and the superior structure 110 can be mounted to the support 184 for rotation about the pivot point 148. The actuation system 112 includes an oscillation mechanism 150 that is coupled to the support 184. Operation of the oscillation mechanism 150 induces back and forth movement of the inferior structure 108 and the superior structure 110 about the pivot point 148 along an arcuate path 141 that intersects a vertical axis 140 of the vertical system 104. In an example embodiment, the degree of the arcuate path in each direction relative to the vertical axis 140 of the vertical system 104 may be in the range of 0.1 to 45 degrees.

In one example configuration, the oscillation mechanism 150 includes a rotator 160 offset from a vertical axis 140 of the vertical system 104, and a rigid arm 162 that is coupled at one end to one or more posts 120, 138 of the inferior structure 108 and the superior structure 110 and at the other end to the rotator. Rotation of the rotator 160 translates, via the rigid arm 162, to side-to-side pulling and pushing of the lower end of post, which in turn translates to oscillation of the inferior structure 108 and the superior structure 110 about the pivot point 148. The rotator 160 may be a commercially available rotary actuator, e.g., a rack-and-pinion rotary actuator, that may be modified to fit within the housing of the actuation system 112. The rotator 160 may be a mechanical or electro mechanical rotary actuator, a hydraulic rotary actuator, a pneumatic rotary actuator, or functional equivalents thereof.

The arcuate oscillation feature is controlled based on a control signal 136 output by the controller 126 to the oscillation mechanism 150. In one configuration, the controller 126 includes a second rotatable dial 180 that turns the arcuate oscillation feature on and off. When the arcuate oscillation feature is on, further rotation of the second rotatable dial 180 sets the speed of oscillation, i.e., the time it takes to complete one side-to-side swing where the swing starts at vertical (FIG. 3A), swings to one side (e.g., to the right as shown FIG. 3B) and then to the other side (e.g., to the left as shown FIG. 3C) and then returns to vertical (as shown in FIG. 3A). The speed of arcuate oscillation may be in the range of 0.5 to 10 seconds. In one configurations, the controller 126 includes a third rotatable dial 182, the rotation of which sets the degree of swing in the range of 0.1 to 45 degrees.

With reference to FIGS. 4A-4C, in some embodiments, the actuation system 112 is configured to cause the inferior structure 108 and the superior structure 110 to oscillate back and forth along a linear path 143. Note, in FIGS. 4A-4C some components of the actuation system 112 shown in FIG. 2 are not included for clarity of illustration. These components include the housing 124, the superior actuator 114, and the inferior actuator 116.

Continuing with FIGS. 4A-4C, the actuation system 112 includes an oscillation mechanism 186. Operation of the oscillation mechanism 186 induces back and forth movement of the inferior structure 108 and the superior structure 110 along a linear path 143 that intersects the vertical axis 140 of the vertical system 104. In an example embodiment, the distance of the linear path 143 in each direction relative to the vertical axis 140 of the vertical system 104 may be in the range of 0.5 to 6 inches.

In one example configuration, the oscillation mechanism 186 includes a slide support 188 arrange generally orthogonal to the vertical axis 140 of the vertical system 104, a slide coupling 190 that is fixedly coupled at one end to one or more posts 120, 138 of the inferior structure 108 and the superior structure 110 and slidably coupled at the other end to the slide support. The slide support 188 can be one or more rails, tubes, pipes or bars. In the case of tubes, pipes, or bars, the slide coupling 190 can be one or more sleeves that have a slightly larger diameter that allows the sleeves to slide back and forth over the tubes, pipe, or bars. In the case of a slide support 188 configured as a rail, the slide coupling 190 can be one or more wheels. The oscillation mechanism 186 further includes an actuator 192 that is coupled to the slide coupling 190. Actuation of the actuator 192 translates, via the slide coupling 190, to side-to-side pulling and pushing of the lower end of the one or more posts 120, 138 of the inferior structure 108 and the superior structure 110, which in turn translates to linear oscillation of the inferior structure and the superior structure along the slide support 188.

In the embodiment of FIGS. 4A-4C, the actuator 192 may be a linear actuator similar to the actuators 114, 116 that enable up and down movement of the inferior structure 108 and the superior structure 110. The actuator 192 may be a mechanical or electro mechanical linear actuator, a hydraulic linear actuator, a pneumatic linear actuator, a piezoelectric actuators, a solenoid actuator, or functional equivalents thereof. In another embodiment, the actuator 192 may be a rotation mechanism similar to the rotator 160 that enable arcuate motion of the inferior structure 108 and the superior structure 110. The actuator 192 may be a commercially available rotary actuator, e.g., a rack-and-pinion rotary actuator. The actuator 192 may be a mechanical or electro mechanical rotary actuator, a hydraulic rotary actuator, a pneumatic rotary actuator, or functional equivalents thereof.

In either case, the linear oscillation feature is controlled based on a control signal 194 output by the controller 126 to the oscillation mechanism 186. In one configuration, the controller 126 includes a rotatable dial that turns the linear oscillation feature on and off. When the linear oscillation feature is on, further rotation of the rotatable dial sets the speed of oscillation, i.e., the time it takes to complete one side-to-side slide where the slide begins at a starting point aligned with the vertical axis (FIG. 4A), slides to one side (e.g., to the right as shown FIG. 4B) and then to the other side (e.g., to the left as shown FIG. 4C) and then returns to the starting point (as shown in FIG. 4A. The speed of linear oscillation may be in the range of 0.5 to 10 seconds. In one configurations, the controller 126 includes a third rotatable dial 182, the rotation of which sets the total side-to-side distance of the linear slide in the range of 0.5 to 6 inches.

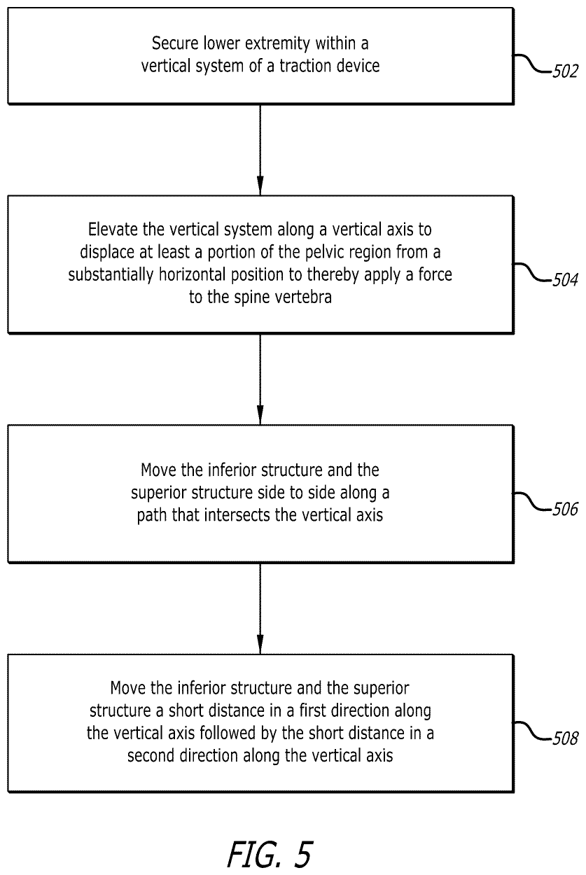

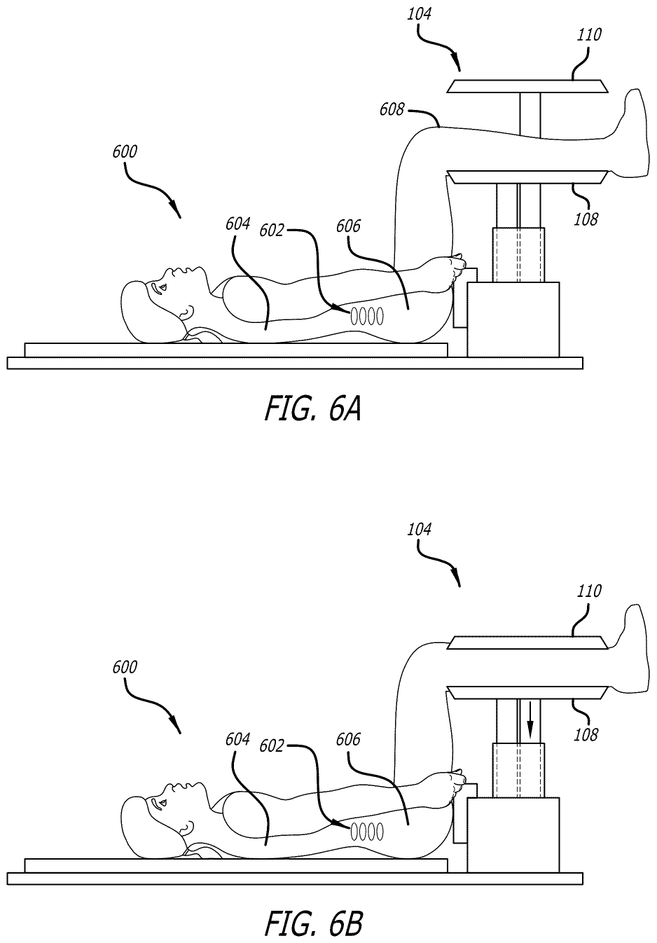

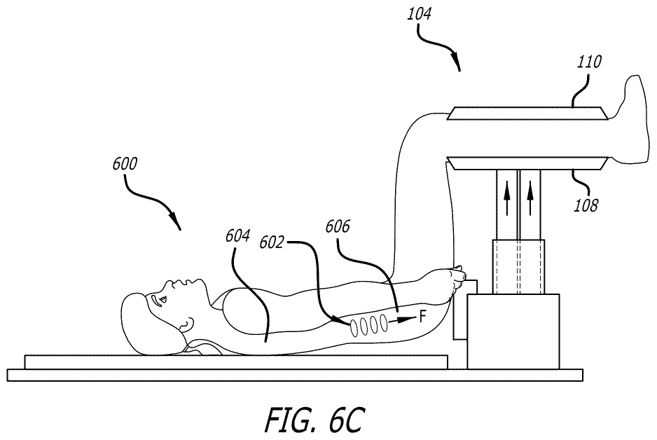

FIG. 5 is a flowchart of a method of applying a pulling force to spine vertebra using the traction device of FIGS. 1A-2. With additional reference to FIG. 6A, the method may be performed on a person 600 who is initially lying with their torso 604 and pelvic region 606 substantially horizontal and the lower portion of their leg including the calf and tibia, i.e., lower extremity 608, above the torso and positioned between an inferior structure 108 and a superior structure 110 of the traction device.

At block 502 and with additional reference to FIG. 6B, the lower extremity of the person is secured between the inferior structure 108 and the superior structure 110. To this end, in some embodiments the superior structure 110 is moved downward toward the inferior structure 108. The movement may be electronically controlled based on a control signal output by a controller 126 to the superior actuator 114. The movement may be mechanically controlled through a mechanical button that operates the superior actuator 114. In other embodiments, the inferior structure 108 may be moved upward toward the superior structure 110. The movement may be electronically controlled based on a control signal output by a controller 126 to the inferior actuator 116. The movement may be mechanically controlled through a mechanical button that operates the inferior actuator 116. In other embodiments, the inferior structure 108 and the superior structure 110 may be moved toward each other.

At block 504 and with additional reference to FIG. 6C, the inferior structure 108 and the superior structure 110 are elevated along a vertical axis 140 to displace at least a portion of the pelvic region from its substantially horizonal position to thereby apply a pulling force to the spine vertebra 602. To this end, the inferior structure 108 and the superior structure 110 are moved upward along the vertical axis 140 based on one or more control signals output by a controller 126. In some embodiments, movement of the inferior structure 108 and movement of the superior structure 110 is simultaneous. In other embodiments, movement of the inferior structure 108 and the superior structure 110 is alternating, wherein the superior structure 110 is moved upward without moving the inferior structure 108, and then the inferior structure 108 is moved upward without moving the superior structure 110.

At block 506, in some embodiments the inferior structure 108 and the superior structure 110 are moved back and forth along a path 141, 143 that intersects the vertical axis 140. The path may be an arcuate path 141 or a linear path 143. The degree of the arcuate path 141 and the distance of the linear path 143 and the speed of the back and forth movement can be set/controlled as described above. This back and forth movement helps add lateral force to the traction force and adds a relaxing motion that also works as a distraction allowing the patient to relax and be stretched.

At block 508, in some embodiments brief movements occur during which the inferior structure 108 together with the superior structure 110 moves a short distance in a first direction, e.g., up, along the vertical axis 140 followed by the short distance in a second direction, e.g., down, along the vertical axis opposite the first direction. The short distance can be in the range of 0.1 to 6 inches and the speed of movement in the first direction may be slow or quick/sudden. The movement in the second direction can immediately follow the movement in the first direction. The speed of movement in the second direction may be slow or quick/sudden. Quick/sudden movements in the first and second directions to provide a low impact jolting movement that helps restore a patient's kinetic chain. The frequency of these brief movements can be set/controlled as described above.

The various aspects of this disclosure are provided to enable one of ordinary skill in the art to practice the present invention. Various modifications to exemplary embodiments presented throughout this disclosure will be readily apparent to those skilled in the art, and the concepts disclosed herein may be extended to other magnetic storage devices. Thus, the claims are not intended to be limited to the various aspects of this disclosure, but are to be accorded the full scope consistent with the language of the claims.

What is claimed is:

1. A traction device for applying a force to a joint of a person, the traction device comprising:
a vertical system having a vertical axis, the vertical system configured to support respective portions of one or more legs of the person, and comprising:
an inferior structure;
a superior structure above the inferior structure; and
an actuation system configured to adjust a distance d1 between the superior structure and the inferior structure and a distance d2 between the inferior structure and a reference plane beneath the inferior structure through movement of one or both of the superior structure and the inferior structure along the vertical axis.

2. The traction device of claim 1, wherein the actuation system comprises:
a superior actuator coupled to the superior structure;
an inferior actuator coupled to the inferior structure; and
an controller configured to control operation of the superior actuator and the inferior actuator.

3. The traction device of claim 2, wherein the controller is configured to:
control an operation of the superior actuator to move the superior structure, and
control an operation of the superior actuator and the inferior actuator to simultaneously move the superior structure and the inferior structure.

4. The traction device of claim 2, wherein the superior actuator and the inferior actuator are mechanically coupled relative to each other such that:
operation of the superior actuator moves the superior structure without moving the inferior structure; and
operation of the inferior actuator moves the inferior structure together with the superior structure.

5. The traction device of claim 2, wherein:
the superior actuator further comprises a sensor configured to output a measurement indicative of resistance against movement of the superior structure, and
the superior actuator is configured to override the controller to stop movement of the superior structure by the superior actuator when the measurement exceeds a threshold.

6. The traction device of claim 2, wherein:
the inferior actuator further comprises a sensor configured to output a measurement indicative of resistance against movement of the inferior structure, and
the inferior actuator is configured to override the controller to stop up movement of the inferior structure when the measurement exceeds a threshold.

7. The traction device of claim 2, wherein the controller is configured to control an operation of one or both of the superior actuator and the inferior actuator to simultaneously move the inferior structure with the superior structure a short distance in a first direction followed by the short distance in a second direction opposite the first direction, where the short distance is in a range of 0.1 to 6 inches.

8. The traction device of claim 1, further comprising an oscillation mechanism coupled to the inferior structure and the superior structure, and configured to move the inferior structure and the superior structure along a path that intersects the vertical axis.

9. The traction device of claim 8, wherein the oscillation mechanism has a pivot point and comprises a rotation system configured to move the inferior structure and the superior structure relative to the pivot point along an arcuate path.

10. The traction device of claim 8, wherein the oscillation mechanism comprises a linear slide system configured to move the inferior structure and the superior structure along a linear path.

11. The traction device of claim 1, wherein the inferior structure comprises a vibrating mechanism.

12. The traction device of claim 1, wherein the superior structure comprises a vibrating mechanism.

13. The traction device of claim 1, further comprising a horizontal base coupled to the vertical system.

14. The traction device of claim 1, further comprising a mechanism configured to couple to a horizonal support structure.

15. A method of applying a pulling force to spine vertebra of a person, the method comprising:
while the person is lying with their torso and pelvic region substantially horizontal with one or more lower extremities above the torso, securing the one or more lower extremities between an inferior structure and a superior structure of a traction device; and
elevating the inferior structure and the superior structure along a vertical axis to displace at least a portion of the pelvic region from its substantially horizonal position to thereby apply the pulling force to the spine vertebra.

16. The method of claim 15, wherein securing the one or more lower extremities between the inferior structure and the superior structure comprises moving the superior structure down.

17. The method of claim 15, wherein elevating the inferior structure and the superior structure comprises simultaneously moving the inferior structure and the superior structure up.

18. The method of claim 15, further comprising:
moving the inferior structure and the superior structure along a path that intersects the vertical axis.

19. The method of claim 18, wherein the path is one of an arcuate path or a linear path.

20. The method of claim 16, further comprising:
moving the inferior structure together with the superior structure a short distance in a first direction along the vertical axis followed by the short distance in a second direction along the vertical axis opposite the first direction, where the short distance is in a range of 0.1 to 6 inches.
